(19) United States
(12) Patent Application Publication
(10) Pub. No.: US 2021/0217035 A1
(43) Pub. Date: Jul. 15, 2021

(54) FAIR PRICE ESTIMATOR

(71) Applicant: Mastercard International Incorporated, Purchase, NY (US)

(72) Inventors: Kyle T. Williams, Wentzville, MO (US); David J. Senci, Troy, IL (US); Arjun Neeraj Jain, O'Fallon, MO (US)

(73) Assignee: Mastercard International Incorporated, Purchase, NY (US)

(21) Appl. No.: 16/740,819

(22) Filed: Jan. 13, 2020

(51) Int. Cl. G06Q 30/02; G06N 7/00; G06F 16/248; G06F 16/26; G06T 11/20

(52) U.S. Cl. CPC G06Q 30/0206; G06Q 30/0205; G06N 7/005; H04L 12/28; G06F 16/26; G06T 11/206; G06F 16/248

(57) ABSTRACT

A fair price estimator system has a memory device and a processor programmed to receive historical transaction data including historical payment transactions between account holders and merchants. The transaction data includes a merchant name, category code (MCC), and location associated with each of the payment transactions. The processor generates a first subset of data based on predetermined transaction parameters and stores the first subset in the memory device. The processor receives, from a consumer, a first input value including one or more of a merchant name and/or an MCC that are included in the first subset of data, and a second input value including a location identifier. The processor generates a second subset of data from the first subset based on the input values. The processor then determines one or more transaction value properties of the second subset of data and presents to the consumer the one or more transaction value properties.

### FIELD OF THE DISCLOSURE

The field of the disclosure relates generally to payments transaction data and, more particularly, to a system for determining a fair price score for a consumer based on historical payment transaction data.

### BACKGROUND OF THE DISCLOSURE

Typically, subscription and/or utility service merchants offer many different promotions, plans, and discounts to consumers for the merchants' services. The various promotions, plans, and discounts can make it difficult for a consumer to determine whether he or she is paying a fair price for the service. A consumer may believe he or she is paying a fair price only to discover later that other consumers are paying less for the same or similar service. Typically a consumer has no way to determine whether an offer being presented by the merchant is reasonable or good relative to the merchant's other consumers.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a fair price estimator system is provided. The system includes a memory device for storing data and a processor communicatively coupled to the memory device. The processor is programmed to receive historical transaction data having a plurality of historical payment transactions between a plurality of account holders and a plurality of merchants. The historical transaction data includes a merchant name, a merchant category code, and a merchant location associated with each of the historical payment transactions. The processor is also programmed to generate a first subset of transaction data from the historical transaction data based on one or more predetermined transaction parameters, and to store the first subset of transaction data in the memory device. Furthermore, the processor is also programmed to receive, from a consumer, a first input value. The first input value includes one or more of a merchant name and a merchant category code included in the first subset of transaction data. The processor is also programmed to receive a second input value including a location identifier. In addition, the processor is programmed to generate a second subset of transaction data from the first subset of transaction data based on the first and second input values received from the consumer, and to determine one or more transaction value properties of the second subset of transaction data. Moreover, the processor is also programmed to present to the consumer the one or more transaction value properties.

In another aspect, another fair price estimator system is provided. The system includes a memory device for storing data, and a processor communicatively coupled to the memory device. The processor is programmed to receive, from a consumer, a consumer payment account number. Based on one or more predetermined transaction parameters, the processor retrieves consumer transaction data corresponding to the consumer payment account number. The consumer transaction data corresponds to historical consumer payment transactions associated with the consumer payment account number. The consumer transaction data includes a merchant name, a merchant category code, a transaction value, and a merchant location associated with each of the historical consumer payment transactions. Furthermore, the processor is also programmed to receive, from the consumer, a first input value. The first input value includes one or more of a merchant name and a merchant category code included in the consumer transaction data. The processor is also programmed to determine one or more consumer transaction value properties of the consumer transaction data based on the first input value received from the consumer. Moreover, the processor is also programmed to retrieve historical transaction data having a plurality of historical payment transactions between a plurality of account holders and a plurality of merchants. The historical transaction data includes a merchant name, a merchant category code, a transaction value, and a merchant location associated with each of the historical payment transactions. In addition, the processor is also programmed to generate a first subset of transaction data from the historical transaction data based on the one or more predetermined transaction parameters, and to store the first subset of transaction data in the memory device. Further, the processor is also programmed to receive, from the consumer, a second input value including a location identifier and to generate a second subset of transaction data from the first subset of transaction data based on the first and second input values received from the consumer. The processor determines one or more historical transaction value properties of the second subset of transaction data, and presents, to the consumer, the one or more consumer transaction value properties and the one or more historical transaction value properties.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a simplified block diagram of an example multi-party payment card network system having a fair price estimator module, in accordance with one embodiment of the present disclosure;

FIG. 2 is a simplified block diagram of a payment network having a transaction processing system for processing historical payments transaction data using the fair price estimator module shown in FIG. 1;

FIG. 3 is an expanded block diagram of an example embodiment of a server architecture of a payment processing system in accordance with one embodiment of the present disclosure;

FIG. 4 is an example configuration of a user system operated by a user, such as the consumer shown in FIG. 1;

FIG. 5 is an example configuration of a server system for use in the payment card network system shown in FIG. 1;

FIG. 6 is a flowchart illustrating an exemplary computer-implemented method for determining transaction value properties for recurring payments, in accordance with one embodiment of the present disclosure;

FIG. 7 is a flowchart illustrating an exemplary computer-implemented method for comparing a consumer's recurring payment amount for a service to a plurality of other consumers' payments for the same and/or similar service, in accordance with one embodiment of the present disclosure; and

FIG. 8 is an example data visualization of one or more consumer transaction value properties and one or more historical transaction value properties presented on a display device of the user system shown in FIG. 4.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application for determining a fair price score of a consumer's recurring payment amount relative to a plurality of other consumers' payments for the same and/or similar service. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL. However, any database may be used that enables the systems and methods to operate as described herein.

Embodiments of the present technology relate to systems, methods, and computer-readable media for evaluating historical transaction data associated with recurring payments to determine a fair price score of a selected consumer. As such, the consumer is able to determine from the fair price score whether the consumer is receiving a fair price relative to a plurality of similarly situated consumers.

According to one embodiment of the disclosure, a computing system is configured to receive, from the consumer, a consumer payment account number. Based on one or more predetermined transaction parameters, the computing system retrieves consumer transaction data corresponding to the consumer payment account number. The consumer transaction data corresponds to historical consumer payment transactions associated with the consumer payment account number. In addition, the consumer transaction data includes a merchant name, a merchant category code, a transaction value, and a merchant location associated with each of the historical consumer payment transactions.

The consumer inputs one or more of a merchant name and a merchant category code (MCC) into the computing system, where the merchant name and/or the MCC is one that is included in the consumer's historical transaction data. As such, the computing system can identify certain payment transactions of the consumer for determining the fair price score. The computing system determines one or more consumer transaction value properties based on the input merchant name and/or MCC. For example, the computing system may determine an average price the consumer is paying for a particular recurring service (e.g., a cable bill or utility service).

The computing system also retrieves historical transaction data of a plurality of historical payment transactions between a plurality of account holders and a plurality of merchants. The historical transaction data also includes a merchant name, a merchant category code, a transaction value, and a merchant location associated with each of the historical payment transactions. In one embodiment, the computing system identifies all of the approved transactions that are recurring.

The computing system receives from the consumer a location for use in determining the fair price score of the consumer. For example, the consumer may wish to determine his or her fair price score for a cable service bill in their local zip code. In such an instance, the consumer would input their zip code into the computing system. Using this zip code, the computing system would generate a subset of transaction data that matches the zip code. The computing system may evaluate the subset of transactions to determine various statistical properties of the data, such as an average transaction value, the minimum and maximum transactions values, and the median and mode values. These values can be presented to the consumer along with the consumer's average price for the same service. In addition, the computing system determines the consumer's fair price score using these data points.

As will be appreciated, based upon the description herein, the technical improvement in scoring a consumer's recurring payment relative to other consumers' recurring payments for the same or similar services, as described is a computer-based solution to a technical deficiency or problem that is itself rooted in computer technology (i.e., the problem itself derives from the use of computer technology). More specifically, the technical problems and inefficiencies created accessing financial account data associated with only a single consumer are the result of an implementation and use of computers in financial institution processing systems and methods intended to keep the financial account data private and secured. The present disclosure improves upon the conventional methods and systems in the manners described herein. Thus, the inefficiencies or technical problems created by the financial institution data processing systems and methods as described herein are solved by the methods and systems described and particularly claimed.

### Payment Network Systems

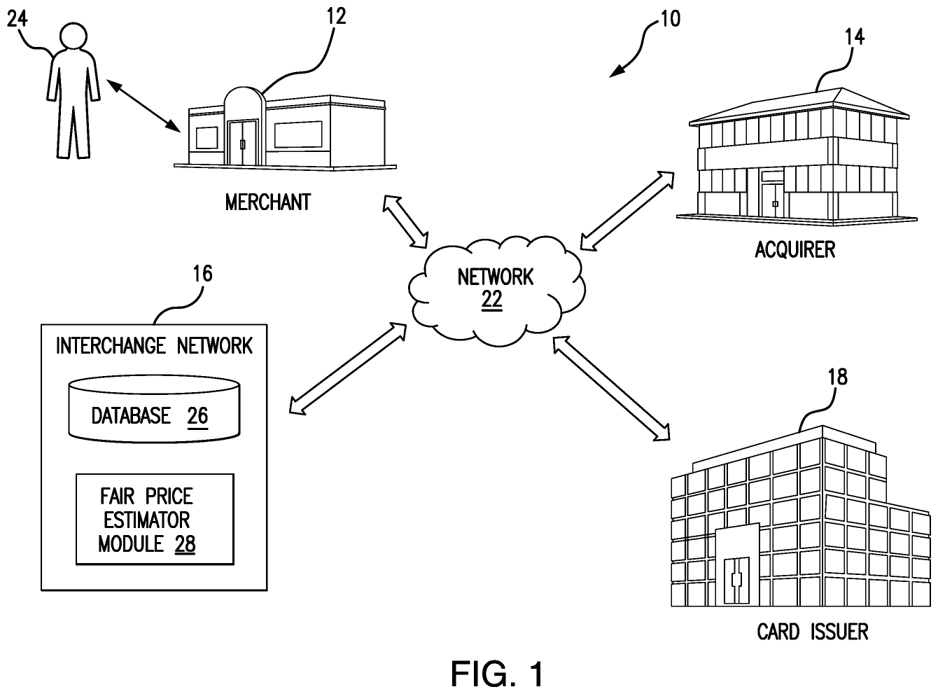

FIG. 1 is a block diagram of an example multi-party payment card network system 10 having a fair price estimator module 28 (broadly, a fair price estimator system). The payment card network system 10 facilitates providing interchange network services offered by an interchange network 16. In addition, the payment card network system 10 enables payment card transactions in which merchants 12, acquirers 14, and/or card issuers 18 do not need to have a one-to-one relationship. Although parts of the payment card network system 10 are presented in one arrangement, other embodiments may include the same or different parts arranged otherwise, depending, for example, on authorization processes for purchase transactions, communication between computing devices, etc.

The fair price estimator module 28 is a specially programmed computer system that enables transaction data and merchant data available from multi-party payment card network system 10 to be used for determining various transaction value properties for subscription and/or utility payment transactions (or other recurring payments) and how such properties compare to a cardholder's or consumer's payments for substantially similar services and/or to substantially similar merchants. (Note that “cardholder” and “consumer” are used interchangeably.) In some cases, the cardholder is an account holder that initiates transactions processed by payment card network system 10. In other cases, anyone with access to the cardholder's payment card, for example, through a website or smartphone app can be a cardholder. The fair price estimator module 28 is specially programmed with a plurality of algorithms that are configured to receive consumer transaction data from the cardholder in the form of historical transaction data, merchant data, and other historical transaction data related to a plurality of consumers. In some instances, the combined data is then used to determine a fair price score for a service provided by a particular merchant and/or merchants of a particular merchant category code (MCC), based in part on merchant location. The fair price score can be used to facilitate determining whether a consumer is receiving and/or paying a fair and/or competitive price for a service offered by a particular merchant and/or merchants of a particular MCC. If the fair price score is low, and in particular, relative to a selected transaction value property for the subscription and/or utility payment transaction being evaluated, the score may indicate that the consumer is receiving or paying a fair or competitive price. However, a high or relatively high score (e.g., relative to a selected transaction value property for the subscription and/or utility payment transaction being evaluated) may indicate that the consumer is not receiving or paying a fair or competitive price.

In the example embodiment, the payment card network system 10 generally includes the merchants 12, the acquirers 14, the interchange network 16, and the issuers 18 coupled in communication via a network 22. The network 22 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the issuers 18. In some embodiments, the network 22 may include more than one type of network, such as a private payment transaction network provided by the interchange network 16 to the acquirers 14 and/or the issuers 18, and, separately, the public Internet, which may facilitate communication between the merchants 12, the interchange network 16, the acquirers 14, and the consumers 24, etc.

Embodiments described herein may relate to a transaction card system, such as a credit card payment system using the Mastercard® interchange network. (Mastercard is a registered trademark of Mastercard International Incorporated.) The Mastercard interchange network is a set of proprietary communications standards promulgated by Mastercard for the exchange of financial transaction data and the settlement of funds between financial institutions that are members of Mastercard. As used herein, financial transaction data includes a unique account number associated with an account holder using a payment card issued by an issuer, purchase data representing a purchase made by the cardholder, including a type of merchant, amount of purchase, date of purchase, and other data, which may be transmitted between any parties of multi-party payment card network system 10.

In a typical transaction card system, a financial institution called the “issuer” issues a payment card, such as a credit card, to a cardholder or consumer 24, who uses the payment card to tender payment for a purchase from the merchant 12. In the example embodiment, the merchant 12 is typically associated with products, for example, and without limitation, goods and/or services, that are offered for sale and are sold to the consumers 24. The merchant 12 includes, for example, a physical location and/or a virtual location. A physical location includes, for example, a brick-and-mortar store, etc., and a virtual location includes, for example, an Internet-based store-front.

To accept payment with the payment card, the merchant 12 must normally establish an account with a financial institution that is part of the payment card network system 10. This financial institution is usually called the “merchant bank,” the “acquiring bank,” or the acquirer 14. When the consumer 24 provides payment for a purchase with a payment card, the merchant 12 requests authorization from the acquirer 14 for the purchase amount. The request may be performed over the telephone but is usually performed using a point-of-sale terminal that reads the cardholder's account information from a magnetic stripe, a chip, or embossed characters on the payment card and communicates electronically with the transaction processing computers of the acquirer 14. However, in some embodiments, the payment card transaction is a card-not-present (CNP) account-on-file transaction in which a payment card is not presented to the merchant 12 during a transaction. In such CNP transactions, for example, the merchant 12 may have stored the cardholder's payment card account information from a previous transaction or may have stored the information based on an agreement for initiating recurring transactions. This information is then communicated electronically with the transaction processing computers of the acquirer 14. Alternatively, the acquirer 14 may authorize a third party to perform transaction processing on its behalf. In this case, the point-of-sale terminal will be configured to communicate with the third party. Such a third party is usually called a “merchant processor,” an “acquiring processor,” or a “third party processor.”

Using the interchange network 16, computers of the acquirer 14 or merchant processor will communicate with computers of the issuer 18 to determine whether the cardholder's account is in good standing and whether the purchase is covered by the cardholder's available credit line. Based on these determinations, the request for authorization will be declined or accepted. If the request is accepted, an authorization code is issued to the merchant 12.

When a request for authorization is accepted, the available credit line of the cardholder's account is decreased. Normally, a charge for a payment card transaction is not posted immediately to the cardholder's account because bankcard associations, such as Mastercard, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the point-of-sale terminal. This may include bundling of approved transactions daily for standard retail purchases. If the consumer 24 cancels a transaction before it is captured, a “void” is generated. If the consumer 24 returns goods after the transaction has been captured, a “credit” is generated. The interchange network 16 and/or the issuer 18 stores the transaction data, such as, and without limitation, a payment account number (PAN), a type of merchant, a merchant identifier, a location where the transaction was completed, an amount of purchase, a merchant category code, a date and time of the transaction, products purchased and related descriptions or identifiers, etc., in a transaction database 26.

After a purchase has been made, a clearing process occurs to transfer additional transaction data related to the purchase among the parties to the transaction, such as the acquirer 14, the interchange network 16, and the issuer 18. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. Usually, transactions are captured and accumulated into a “batch,” which is settled as a group. More specifically, a transaction is typically settled between the issuer 18 and the interchange network 16, and then between the interchange network 16 and the acquirer 14, and then between the acquirer 14 and the merchant 12. It should be appreciated that more or less information related to transactions, as part of either authorization, clearing, and/or settling, may be included in the transaction data and stored within the transaction database 26, at the merchant 12, the acquirer 14, the payment network 16, and/or the issuer 18. Further, transaction data, unrelated to a particular payment account, may be collected by a variety of techniques, and similarly stored within the transaction database 26.

In some embodiments, consumers 24 involved in the transactions described herein are prompted to agree to legal terms associated with their payment accounts, for example, during enrollment in such payment accounts, etc. As such, the consumer 24 may voluntarily agree to allow the merchants 12, the issuers 18, the interchange network 16, etc., to utilize data collected during enrollment and/or collected relating to processing the transactions, subsequently for one or more of the purposes described herein.

Furthermore, the interchange network 16 includes the fair price estimator module 28 that is configured to retrieve and evaluate various data associated with the payment card transactions and provide various information to one or more parties involved in the payment card transaction, such as the consumer 24. Specifically, the fair price estimator module 28 is a specially programmed computer system that enables the interchange network 16 to implement an automated process to retrieve consumer transaction data in the form of historical payment transactions and to receive, from the consumer 24, a selection of one or more of a merchant name and an MCC included in the consumer transaction data. After receiving the transaction data and selection, the fair price estimator module 28 determines one or more consumer transaction value properties of the consumer transaction data based on the consumer selection. Furthermore, the fair price estimator module 28 retrieves historical transaction data of a plurality of historical payment transactions between a plurality of account holders and a plurality of merchants and receives, from the consumer 24, a location identifier associated with a location to which the consumer would like pricing information. The fair price estimator module 28 then determines one or more historical transaction value properties of historical transaction data and presents to the consumer 24 the consumer transaction value properties and the historical transaction value properties.

While only one merchant 12, acquirer 14, interchange network 16, and issuer 18 are shown in FIG. 1 (for ease of reference), it should be appreciated that a variety of other embodiments may include multiple ones of these parties in various combinations.

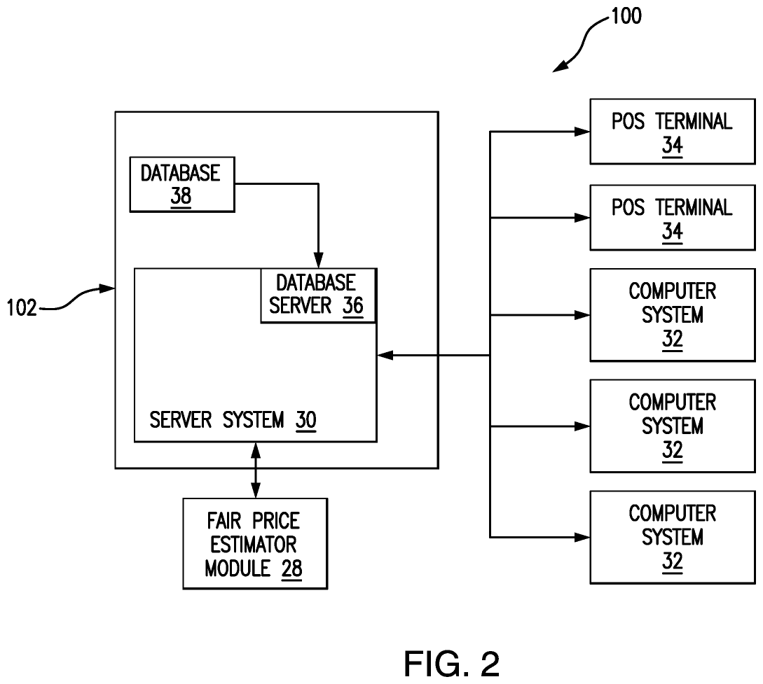

FIG. 2 is a simplified block diagram of a payment network 100 having an example transaction processing system 102 for processing historical payments transaction data using the fair price estimator module 28. In some embodiments, the payment network 100 is similar to the payment card network system 10 (shown in FIG. 1). In the exemplary embodiment, the payment network 100 includes a plurality of computing devices connected in accordance with the present disclosure. The payment network 100 includes a server system 30 of the transaction processing system 102 coupled in communication with a point-of-sale (POS) terminal 34 located at a merchant 12 (shown in FIG. 1), and/or other client systems 32 associated with merchants, merchant banks, payment networks, and/or issuer banks.

More specifically, in the exemplary embodiment, the transaction processing system 102 includes the server system 30 of, for example, the interchange network 16 (shown in FIG. 1), coupled in communication with the POS terminal 34 and the client systems 32. The server system 30 is also coupled in communication with a plurality of client sub-systems, also referred to as the client systems 32. In one embodiment, the client systems 32 are computers including a web browser, such that server system 30 is accessible to the client systems 32 using the Internet. The client systems 32 are interconnected to the Internet through one or more of many interfaces including, for example, a network, such as a LAN or WAN, dial-in-connections, cable modems, and/or special high-speed Integrated Services Digital Network (ISDN) lines. The client systems 32 could be any device capable of interconnecting to the Internet including an Internet connected phone, a PDA, or any other suitable web-based connectable equipment.

The transaction processing system 102 also includes one or more POS terminals 34, which may be connected to the client systems 32 and may be connected to the server system 30. The POS terminals 34 may be interconnected to the Internet (or any other network that allows the POS terminals 34 to communicate as described herein) through any one or more of a number of interfaces including a network, such as a local area network (LAN) or a wide area network (WAN), dial-in-connections, cable modems, wireless modems, and special high-speed ISDN lines. The POS terminals 34 are any device capable of interconnecting to the Internet and including an input device capable of reading information from a cardholder's financial payment card. In some embodiments, the POS terminal 34 may be a cardholder's personal computer, such as when conducting an online purchase through the Internet. As used herein, the terms POS device, POS terminal, and point of interaction device are used broadly, generally, and interchangeably to refer to any device in which a cardholder interacts with a merchant to complete a payment card transaction.

A database server 36 is connected to a database 38, which is configured to store information on a variety of matters, including the historical transaction data and merchant identification/location data as described herein in greater detail. In one embodiment, the database 38 is a centralized database stored on the server system 30 and can be accessed by potential users at one of the client systems 32 by logging onto the server system 30 through one of the client systems 32. In an alternative embodiment, the database 38 is stored remotely from the server system 30 and may be a distributed or non-centralized database.

In one example embodiment, the database 38 may include a single database having separated sections or partitions or may include multiple databases, each being separate from each other. The database 38 may store transaction data generated as part of sales activities and savings activities conducted over the processing network including data relating to merchants, account holders or customers, issuers, acquirers, savings amounts, savings account information, and/or purchases made. The database 38 may also store account data including at least one of a cardholder name, a cardholder address, an account number, and other account identifiers. The database 38 may also store merchant data including a merchant identifier that identifies each merchant registered to use the network, and instructions for settling transactions including merchant bank account information. The database 38 may also store purchase data associated with items being purchased by a cardholder from a merchant, and authorization request data.

In the exemplary embodiment, one of the client systems 32 may be associated with the acquirer 14 (shown in FIG. 1) while another one of the client systems 32 may be associated with the issuer 18 (shown in FIG. 1). The POS terminal 34 may be associated with the merchant 12 (shown in FIG. 1) or may be a computer system and/or mobile computing system used by a cardholder (e.g., the consumer 24 (shown in FIG. 1)) making an on-line purchase or payment. The server system 30 may be associated with the interchange network 16 or another payment processor. In the example embodiment, the server system 30 is associated with a financial transaction processing network, such as the interchange network 16, and may be referred to as an interchange computer system. The server system 30 may be used for processing transaction data. In addition, the client systems 32 and the POS terminals 34 may include a computer system associated with at least one of a merchant, an online bank, a bill payment outsourcer, an acquirer bank, an acquirer processor, an issuer bank associated with a payment card, an issuer processor, a remote payment processing system, a third-party aggregator, and/or a biller.

In the example embodiment, the transaction processing system 102 is in communication with the fair price estimator module 28, which may be associated with the interchange network 16 or with an outside third party in a contractual relationship with the interchange network 16. In the example embodiment, the fair price estimator module 28 evaluates historical transaction data and provides various transaction information to one or more parties involved in the payment transaction, such as the consumer 24. Specifically, the fair price estimator module 28 determines one or more statistical properties of a set of transaction values selected from the historical transactions of a plurality of consumers and compares these properties to one or more statistical properties of a set of transaction values selected from a particular consumer's historical transactions. The fair price estimator module 28 may also determine a score for the consumer's transaction value properties. It is noted that the payment network 100 may include more, fewer, or alternative components and/or perform more, fewer, or alternative actions, including those discussed elsewhere herein.

### Exemplary Computer Systems

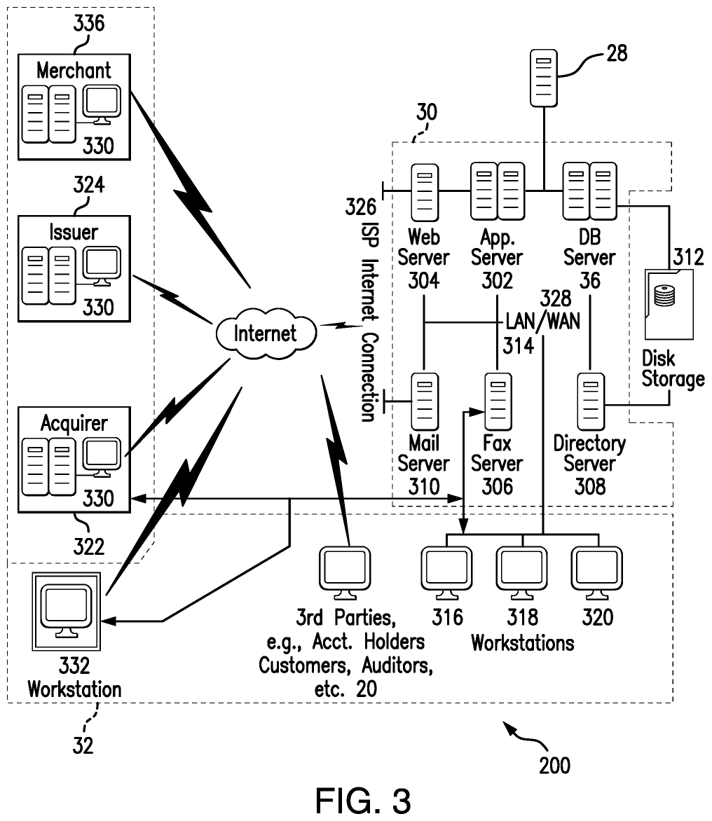

FIG. 3 is an expanded block diagram of an example embodiment of a server architecture of a payment processing system 200 in accordance with one embodiment of the present disclosure. The payment processing system 200 includes the server system 30, the fair price estimator module 28, and the client systems 32. The server system 30 further includes the database server 36, and optionally, an application server 302, a web server 304, a fax server 306, a directory server 308, and a mail server 310. A disk storage unit 312 is coupled to the database server 36 and the directory server 308. The servers 36, 302, 304, 306, 308, and 310 are coupled in communication in a local area network (LAN) 314. In addition, a system administrator's workstation 316, a user workstation 318, and a supervisor's workstation 320 are coupled to the LAN 314. Alternatively, the workstations 316, 318, and 320 are coupled to the LAN 314 using an Internet link or are connected through an Intranet.

In the exemplary embodiment, each of the workstations 316, 318, and 320 is a personal computer having a web browser. Although the functions performed at the workstations typically are illustrated as being performed at respective workstations 316, 318, and 320, such functions can be performed at one of many personal computers coupled to the LAN 314. The workstations 316, 318, and 320 are illustrated as being associated with separate functions only to facilitate an understanding of the different types of functions that can be performed by individuals having access to the LAN 314.

The server system 30 and the fair price estimator module 28 are configured to be communicatively coupled to various entities, including acquirers 322 and issuers 324, and to third parties 20, e.g., account holders, customers, auditors, developers, consumers, merchants, acquirers, issuers, etc., using an Internet connection 326. The server system 30 is also communicatively coupled with one or more merchants 336. The communication in the example embodiment is illustrated as being performed using the Internet, however, any other wide area network (WAN) 328 type communication can be utilized in other embodiments, i.e., the systems and processes are not limited to being practiced using the Internet. In addition, the LAN 314 could be used in place of the WAN 328.

In the example embodiment, any authorized individual or entity having a workstation 330 may access the payment processing system 200. At least one of the client systems 32 includes a manager workstation 332 located at a remote location. The workstations 330 and 332 include personal computers having a web browser. Also, the workstations 330 and 332 are configured to communicate with the server system 30 and the fair price estimator module 28. Furthermore, the fax server 306 communicates with remotely located client systems, including the manager workstation 332, using a telephone link. The fax server 306 is configured to communicate with other client systems 316, 318, and 320 as well.

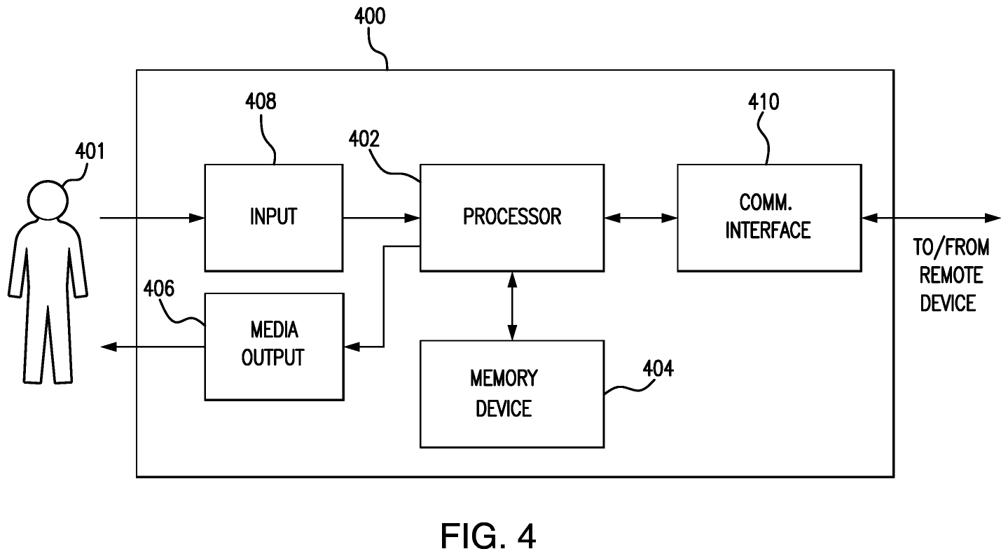

FIG. 4 is an example configuration of a user system 400 operated by a user 401, such as the consumer 24 (shown in FIG. 1). In some embodiments, the user system 400 is a client system 32 and/or a merchant POS terminal 34. In the example embodiment, the user system 400 includes a processor 402 for executing instructions. In some embodiments, executable instructions are stored in a memory device 404. The processor 402 includes one or more processing units, for example, a multi-core configuration. The memory device 404 is any device allowing information such as executable instructions and/or written works to be stored and retrieved. The memory device 404 includes one or more computer readable media.

In the example embodiment, the processor 402 may be implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the computing system 400 may be widely deployed, it may be impractical to manually update software for each computing system 400. Therefore, the systems 10, 100, and/or 200 provide a mechanism for automatically updating the software on the computing system 400. For example, an updating mechanism may be used to automatically update any number of components and their drivers, both network and non-network components, including system level (OS) software components. In some embodiments, the computing system 400 components are dynamically loadable and unloadable; thus, they may be replaced in operation without having to reboot the OS.

The user system 400 also includes at least one media output component 406 for presenting information to the user 401. The media output component 406 is any component capable of conveying information to the user 401. In some embodiments, the media output component 406 includes an output adapter such as a video adapter and/or an audio adapter. An output adapter is operatively coupled to the processor 402 and operatively connectable to an output device such as a display device, for example, and without limitation, a liquid crystal display (LCD), organic light emitting diode (OLED) display, or “electronic ink” display, or an audio output device such as a speaker or headphones.

In some embodiments, the user system 400 includes an input device 408 for receiving input from the user 401. The input device 408 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 406 and the input device 408. The user system 400 may also include a communication interface 410, which is communicatively connectable to a remote device such as the server system 30, the client systems 32, and/or the POS terminals 34 (shown in FIG. 2). The communication interface 410 may include, for example, a wired or wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 404 are, for example, computer readable instructions for providing a user interface to the user 401 via the media output component 406 and, optionally, receiving and processing input from the input device 408. A user interface may include, among other possibilities, a web browser and a client application. Web browsers enable users, such as the user 401, to display and interact with media and other information typically embedded on a web page or a website from the server system 30. A client application allows the user 401 to interact with a server application associated with a merchant.

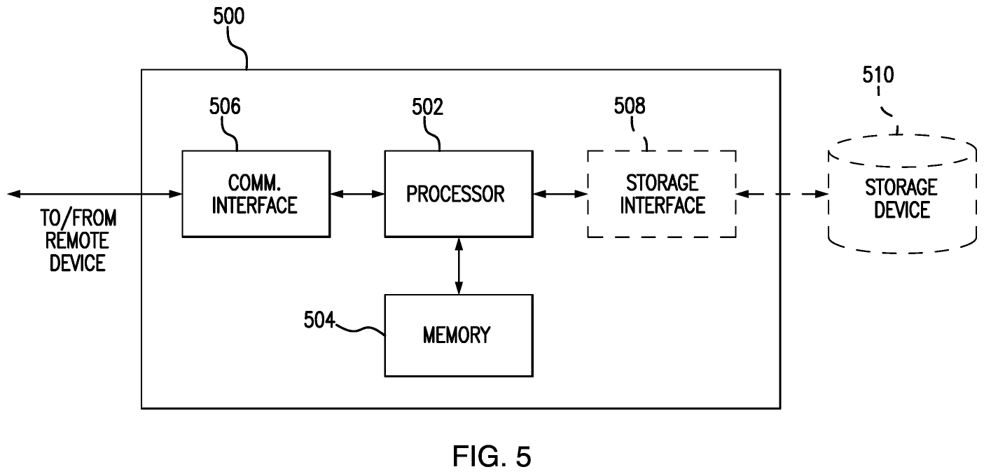

FIG. 5 is an example configuration of a server system 500, such as the server system 30 (shown in FIG. 2). The server system 500 includes, but is not limited to, the transaction database 26 (shown in FIG. 1) and the fair price estimator module 28 (shown in FIG. 1). In the example embodiment, the server system 500 includes a processor 502 for executing instructions. The instructions may be stored in a memory area 504, for example. The processor 502 includes one or more processing units (e.g., in a multi-core configuration) for executing the instructions. The instructions may be executed within a variety of different operating systems on the server system 500, such as UNIX, LINUX, Microsoft Windows®, etc. More specifically, the instructions may cause various data manipulations on data stored in a storage device 510 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.). In the example embodiment, the processor 502 may be implemented as one or more cryptographic processors, as described above with respect to the user system 400.

The processor 502 is operatively coupled to a communication interface 506 such that the server system 500 can communicate with a remote device such as a user system 400 (shown in FIG. 4) or another server system 500. For example, the communication interface 506 may receive communications from a client system 32 via the Internet, as illustrated in FIG. 2.

The processor 502 is operatively coupled to the storage device 510. The storage device 510 is any computer-operated hardware suitable for storing and/or retrieving data. In some embodiments, the storage device 510 is integrated in the server system 500. In other embodiments, the storage device 510 is external to the server system 500 and is similar to the transaction database 26. For example, the server system 500 may include one or more hard disk drives as the storage device 510. In other embodiments, the storage device 510 is external to the server system 500 and may be accessed by a plurality of server systems 500. For example, the storage device 510 may include multiple storage units such as hard disks or solid-state disks in a redundant array of inexpensive disks (RAID) configuration. The storage device 510 may include a storage area network (SAN) and/or a network attached storage (NAS) system.

In some embodiments, the processor 502 is operatively coupled to the storage device 510 via a storage interface 508. The storage interface 508 is any component capable of providing the processor 502 with access to the storage device 510. The storage interface 508 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 502 with access to the storage device 510.

The memory area 504 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

### Exemplary Computer-Implemented Methods

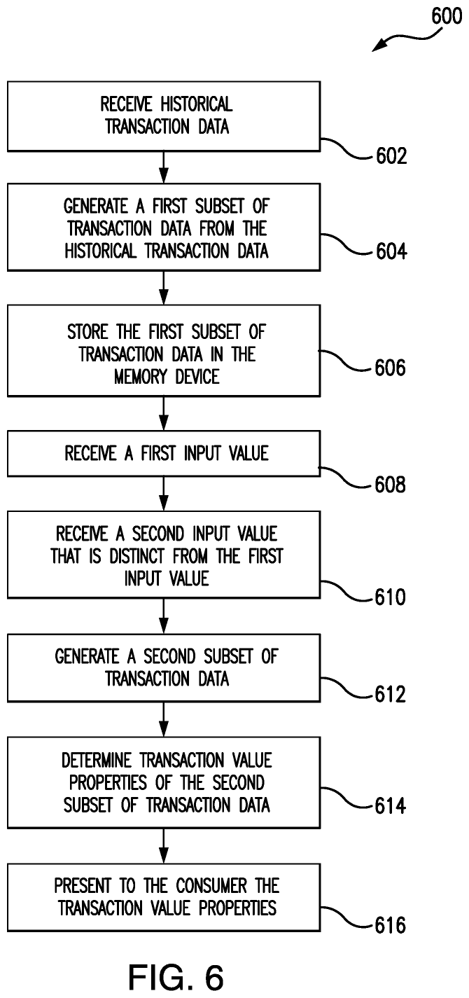

FIG. 6 is a flowchart illustrating an exemplary computer-implemented method 600 for determining transaction value properties for recurring payments using a computer device coupled to a memory device, in accordance with one embodiment of the present disclosure. The operations described herein may be performed in the order shown in FIG. 6 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 600 is described below, for ease of reference, as being executed by exemplary devices and components introduced with the embodiments illustrated in FIGS. 1-5. In one embodiment, the computer-implemented method 600 is implemented by the fair price estimator module 28 (shown in FIG. 1). In the exemplary embodiment, the computer-implemented method 600 relates to receiving historical payment transaction data and determining one or more transaction value properties associated therewith. While operations within the computer-implemented method 600 are described below regarding the fair price estimator module 28, according to some aspects of the present invention, the computer-implemented method 600 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In the exemplary embodiment, the method 600 includes, at an operation 602, receiving, by a processor (e.g., the processor 502 shown in FIG. 5) communicatively coupled to a memory device (e.g., the transaction database 26 shown in FIG. 1), historical transaction data. The received historical transaction data spans a predetermined period. In one embodiment, for example, the predetermined period is a rolling thirteen-month period determined from the date the historical transaction data is received. Alternatively, the predetermined period can include a full year of historical transaction data, a particular number of months of historical transaction data, or any other predetermined period that enables the method 600 to be performed as described herein.

The historical transaction data includes, for example, a plurality of historical payment transactions performed between a plurality of account holders (e.g., one or more consumers 24 shown in FIG. 1) and a plurality of merchants (e.g., one or more merchants 12 shown in FIG. 1). Each of the historical payment transactions include, for example, at least a transaction value (i.e., an amount of the transaction), a merchant name, a merchant category code (MCC), and a merchant location associated with the transaction. In one embodiment, the historical transaction data is received by the fair price estimator module 28 from the payment processor (e.g., the interchange network 16) over the network 22 (each shown in FIG. 1). In other embodiments, the fair price estimator module 28 receives the historical transaction data directly from the payment processor.

At an operation 604, the method 600 includes generating a first subset of transaction data from the historical transaction data based on one or more predetermined transaction parameters. For example, the transaction data may be evaluated, and certain transactions may be chosen for the first subset of transaction data based on the specific transaction type, transaction value, MCC, and the like. In the exemplary embodiment, the one or more predetermined transaction parameters includes transactions that meet each of the following criteria: (i) a recurring transaction; (ii) an approved transaction; and (iii) a transaction value greater than zero (0). In other embodiments, the predetermined transaction parameters can include any type and number of transaction parameters that enable the method 600 to be performed as described herein. After generating the first subset of transaction data, the method 600 includes storing, at an operation 606, the first subset of transaction data in the memory device, such as the transaction database 26.

The method 600 also includes, at an operation 608, receiving, from the consumer 24, for example, a first input value. The first input value includes, for example, one of a merchant name or an MCC that is included in the first subset of transaction data. For example, in one embodiment, the fair price estimator module 28 may obtain the merchant name(s) and the MCC(s) associated with each of the selected historical payment transactions that make up the first subset of transaction data. The obtained merchant name(s) and MCC(s) may be presented to the consumer 24, for example, on a consumer computing device, such as via the media output component 406 of the user system 400 (each shown in FIG. 4). In such an embodiment, the consumer 24 selects from the presented options. Alternatively, in other embodiments, the consumer can input a merchant name and/or an MCC directly via an input device 408 of the consumer computing device.

In the exemplary embodiment, at an operation 610, the method 600 includes receiving a second input value that is distinct from the first input value. The second input value includes a location identifier. The location identifier corresponds to at least one merchant location that is included in the first subset of transaction data. For example, in one embodiment, the fair price estimator module 28 may obtain the location identifier directly from the transaction data that makes up the first subset of transaction data. In another embodiment, the fair price estimator module 28 receives the location identifier from the consumer 24. For example, the consumer 24 may select from a list of one or more merchant locations that are contained in the first subset of transaction data. As described above in association with the merchant name(s) and MCC(s), the fair price estimator module 28 may obtain the merchant location(s) associated with each of the selected historical payment transactions that make up the first subset of transaction data. The obtained merchant locations(s) may be presented to the consumer 24, for example, on the media output component 406 of the user system 400. The location identifier may include, for example, GPS coordinates, a zip code, a city, a state, a distance threshold, and the like, and/or any combination of the same.

At an operation 612, the method 600 includes generating a second subset of transaction data. The second set of transaction data is obtained from the first subset of transaction data and is based on the first and second input values that are received, for example, by the fair price estimator module 28. For example, in one embodiment, the fair price estimator module 28 identifies, using the first input value, a first group of the historical payment transactions from the first subset of transaction data that include the first input value. That is, only those payment transactions that meet the limitation of the merchant name(s) and/or MCC(s) are initially selected. Using the first group of historical payment transactions, the fair price estimator module 28 then identifies a second group that includes the second input value. That is, of the payment transactions that meet the limitation of the merchant name(s) and/or MCC(s), only those payment transactions that meet the limitation of the location identifier are further selected for the second group. The fair price estimator module 28 then generates the second subset of transaction data from the second group of the historical payment transactions.

At an operation 614, the method 600 includes determining one or more transaction value properties of the second subset of transaction data. As described above, each historical payment transaction includes a transaction value that is greater than zero (0). In the exemplary embodiment, the transaction value properties include one or more of the following: (i) a minimum transaction value; (ii) a maximum transaction value; (iii) a range of transaction values; (iv) a mean of the transaction values; (v) a median of the transaction values; and (vi) a mode of the transaction values. As used herein, the “minimum transaction value” is equal to the lowest transaction value of the plurality of transactions that make up the second subset of transaction data and the “maximum transaction value” is equal to the highest transaction value of the plurality of transactions that make up the second subset of transaction data. The “range” of the transaction values is the difference between the maximum transaction value and the minimum transaction value. The “mean” is the average transaction value, or the sum of all the transaction values of the second subset divided by the number of transaction values in the second subset. The “median” is the middle value of the set of transaction values listed in numerical order from the minimum value to the maximum value. The “mode” is the transaction value that occurs most often in the set of transaction values.

At an operation 616, the method 600 includes presenting to the consumer 24 the one or more transaction value properties determined in operation 614. For example, and without limitation, in one embodiment, the fair price estimator module 28 displays the one or more transaction value properties in the form of data visualizations. A data visualization includes a visual representation of the transaction value properties. Such data visualizations can be presented in a number of forms or structures. For example, and without limitation, a data visualization may be presented to the consumer 24 in a chart structure, such as a bar graph, a line graph, a pie chart, or other known chart structure. Alternatively, data visualizations may be presented to the consumer 24 in any type of data structure that enables the method 600 to be performed as described herein.

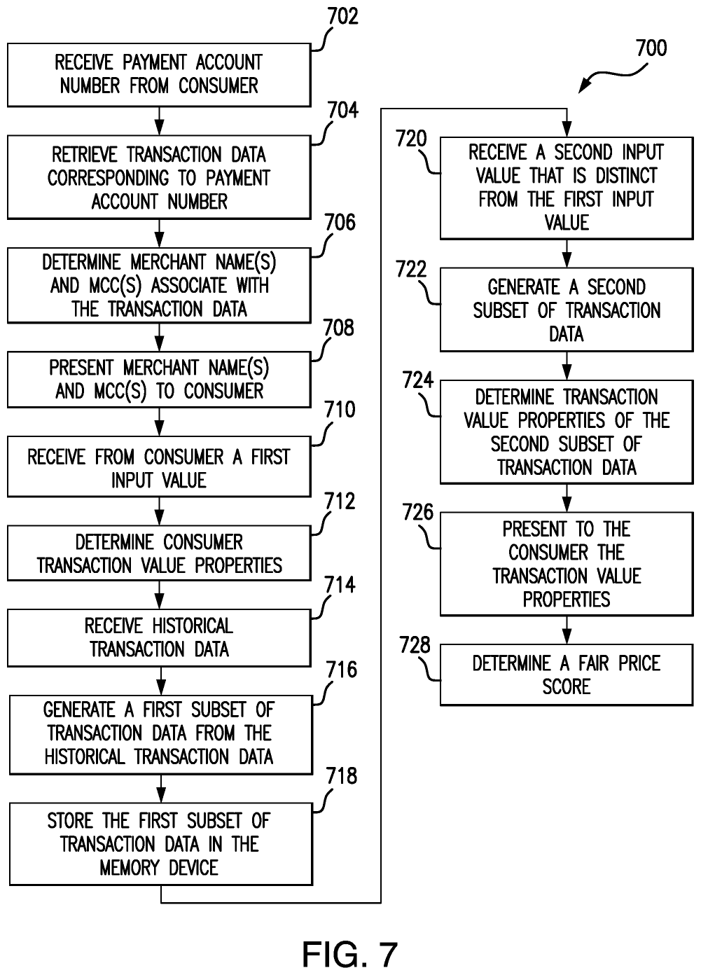

FIG. 7 is a flowchart illustrating an exemplary computer-implemented method 700 for comparing a consumer's recurring payment amount for a service to a plurality of other consumer's payments for the same and/or similar service, using a computer device coupled to a memory device, in accordance with one embodiment of the present disclosure. The operations described herein may be performed in the order shown in FIG. 7 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 700 is described below, for ease of reference, as being executed by exemplary devices and components introduced with the embodiments illustrated in FIGS. 1-5. In one embodiment, the computer-implemented method 700 is implemented by the fair price estimator module 28 (shown in FIG. 1). In the exemplary embodiment, the computer-implemented method 700 relates to receiving historical payment transaction data of a consumer and a selected group of associated consumers and determining one or more transaction value properties associated therewith. While operations within the computer-implemented method 700 are described below regarding the fair price estimator module 28, according to some aspects of the present invention, the computer-implemented method 700 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In the exemplary embodiment, the method 700 includes, at an operation 702, receiving, from the consumer 24, a payment account number. For example, the consumer 24 may use the user system 400 (e.g., a mobile device or computer) to input his or her payment account number to the fair price estimator module 28. The consumer 24 may input the payment account number using a web browser or banking App via a user interface of the user system 400. It is noted that while the consumer 24 may input his or her payment account number directly, as described above, it is contemplated that other methods may be used, including for example, the consumer 24 logging into a user account via a software application associated with the consumer's payment account. In such an embodiment, the fair price estimator module 28 may automatically receive the consumer's payment account number by virtue of its association with the user account.

After the payment account number is received, the method 700 includes, at an operation 704, retrieving, by a processor (e.g., the processor 502 shown in FIG. 5) communicatively coupled to a memory device (e.g., the transaction database 26 shown in FIG. 1), consumer transaction data corresponding to the consumer's payment account number. The consumer transaction data that is retrieved spans a predetermined period. For example, in one embodiment, the predetermined period is a rolling thirteen-month period determined from the date the consumer transaction data is retrieved. Alternatively, the predetermined period can include a full year of consumer transaction data, a particular number of months of consumer transaction data, or any other predetermined period that enables the method 700 to be performed as described herein.

The consumer transaction data generally encompasses one or more predetermined transaction parameters. For example, the consumer transaction data may be evaluated, and certain transactions may be retrieved based on the specific transaction type, transaction value, MCC, and the like. In the exemplary embodiment, the one or more predetermined transaction parameters includes transactions that meet each of the following criteria: (i) a recurring transaction; (ii) an approved transaction; and (iii) a transaction value greater than zero (0). In other embodiments, the predetermined transaction parameters can include any type and number of transaction parameters that enable the method 700 to be performed as described herein.

The retrieved consumer transaction data includes, for example, a plurality of historical consumer payment transactions, where each transaction is typically performed between the consumer 24 and a merchant, such as the merchant 12 (shown in FIG. 1). Each of the historical payment transactions include, for example, at least a transaction value (i.e., an amount of the transaction), a merchant name, a merchant category code (MCC), and a merchant location associated with the transaction. In one embodiment, the consumer's transaction data is retrieved by the fair price estimator module 28 from the payment processor (e.g., the interchange network 16) via the network 22 (each shown in FIG. 1). In other embodiments, the fair price estimator module 28 receives the consumer's transaction data directly from the payment processor.

In one suitable embodiment, the method 700 includes, at an operation 706, determining from the consumer transaction data one or more merchant names and one or more MCCs associated with the historical consumer payment transactions. Furthermore, at an operation 708, the method 700 includes presenting to the consumer for selection, a list of the merchant names and/or MCCs associated with the historical consumer payment transactions. For example, the fair price estimator module 28 may obtain the merchant name(s) and/or the MCC(s) associated with each of the selected historical consumer payment transactions. The obtained merchant name(s) and/or MCC(s) may be presented to the consumer 24, for example, on a consumer computing device, such as via the media output component 406 of the user system 400 (each shown in FIG. 4).

At an operation 710, the method 700 includes receiving from the consumer 24 a first input value. The first input value includes, for example, a selection of one of the merchant name(s) and one of the MCCs included in the consumer transaction data. For example, the consumer 24 selects at least one of the presented options of the obtained merchant name(s) and MCC(s) described in operation 708. Alternatively, in other embodiments, the consumer can input a merchant name and/or an MCC directly via an input device 408 of the consumer computing device.

At an operation 712, the method 700 includes determining one or more consumer transaction value properties of the consumer transaction data. As described above, each historical consumer payment transaction includes a transaction value that is greater than zero (0). In the exemplary embodiment, the consumer transaction value properties include one or more of the following: (i) a most recent transaction value; and (ii) an average of the consumer transaction values. As used herein, the “most recent transaction value” is equal to the transaction value nearest in time when the transactions are arranged in chronological order. The average transaction value is equal to the sum of all the transaction values of the selected historical consumer payment transactions divided by the total number of transaction values being summed.

In the exemplary embodiment, the method 700 also includes, at an operation 714, receiving, by the processor, such as the processor 502, communicatively coupled to a memory device, such as the transaction database 26, historical transaction data. In one suitable embodiment, the historical transaction data spans the same predetermined period as the consumer transaction data, although any predetermined period can be used. The historical transaction data includes, for example, a plurality of historical payment transactions performed between a plurality of account holders (e.g., one or more consumers 24) and a plurality of merchants (e.g., one or more merchants 12). Each of the historical payment transactions include, for example, at least a transaction value (i.e., an amount of the transaction), a merchant name, an MCC, and a merchant location associated with the transaction. In one embodiment, the historical transaction data is received by the fair price estimator module 28 from the payment processor (e.g., the interchange network 16) via the network 22 (each shown in FIG. 1). In other embodiments, the fair price estimator module 28 receives the historical transaction data directly from the payment processor.

At an operation 716, the method 700 includes generating a first subset of transaction data from the historical transaction data based on the one or more predetermined transaction parameters. For example, transaction data may be evaluated, and certain transactions may be chosen for the first subset of transaction data based on the specific transaction type, value, MCC, and the like. In the exemplary embodiment, the one or more predetermined transaction parameters include, as described above, transactions that are (i) recurring transactions, (ii) approved transactions, and (iii) have transaction values greater than zero (0). In other embodiments, the predetermined transaction parameters can include any type and number of transaction parameters that enable the method 700 to be performed as described herein. After generating the first subset of transaction data, the method 700 includes storing, at an operation 718, the first subset of transaction data in the memory device, such as the transaction database 26.

In the exemplary embodiment, at an operation 720, the method 700 includes receiving from the consumer 24 a second input value, which includes a location identifier. The location identifier corresponds to at least one merchant location that is included in the first subset of transaction data. For example, in one embodiment, the fair price estimator module 28 may obtain the location identifier directly from the transaction data that makes up the first subset of transaction data. In another embodiment, the fair price estimator module 28 receives the location identifier from the consumer 24. For example, the consumer 24 may select from a list of one or more merchant locations that are contained in the first subset of transaction data. As described above in association with the merchant name(s) and MCC(s), the fair price estimator module 28 may obtain the merchant location(s) associated with each of the selected historical payment transactions that make up the first subset of transaction data. The obtained merchant locations(s) may be presented to the consumer 24, for example, on the media output component 406 of the user system 400. The location identifier may include, for example, GPS coordinates, a zip code, a city, a state, a distance threshold, and the like, and/or any combination of the same.

At an operation 722, the method 700 includes generating a second subset of transaction data. The second subset set of transaction data is obtained from the first subset of transaction data and is based on the first and second input values that are received from the consumer, for example, by the fair price estimator module 28. For example, in one embodiment, the fair price estimator module 28 identifies a first group of the historical payment transactions from the first subset of transaction data that include the first input value. That is, only those payment transactions that meet the limitation of the merchant name(s) and/or MCC(s) are initially selected. Using the first group of historical payment transactions, the fair price estimator module 28 then identifies a second group that includes the second input value. That is, of the payment transactions that meet the limitation of the merchant name(s) and/or MCC(s), only those payment transactions that meet the additional limitation of the location identifier are further selected for the second group. The fair price estimator module 28 then generates the second subset of transaction data from the second group of the historical payment transactions.

At an operation 724, the method 700 includes determining one or more historical transaction value properties of the second subset of transaction data. Each historical payment transaction includes a transaction value that is greater than zero (0). In the exemplary embodiment, the historical transaction value properties include one or more of the following: (i) a minimum transaction value; (ii) a maximum transaction value; (iii) a range of transaction values; (iv) a mean of the transaction values; (v) a median of the transaction values; and (vi) a mode of the transaction values. As used herein, the “minimum transaction value” is equal to the lowest transaction value of the plurality of transactions that make up the second subset of transaction data and the “maximum transaction value” is equal to the highest transaction value of the plurality of transactions that make up the second subset of transaction data. The “range” of the transaction values is the difference between the maximum transaction value and the minimum transaction value. The “mean” is the average transaction value, or the sum of all the transaction values of the second subset divided by the number of transaction values in the second subset. The “median” is the middle value of the set of transaction values listed in numerical order from the minimum value to the maximum value. The “mode” is the transaction value that occurs most often in the set of transaction values.

At an operation 726, the method 700 includes presenting to the consumer 24 the one or more consumer transaction value properties determined in operation 712 and the one or more historical transaction value properties determined in operation 724. For example, and without limitation, in one embodiment, the fair price estimator module 28 displays the consumer and historical transaction value properties together in the form of data visualizations. As described above, a data visualization includes a visual representation of the transaction value properties. Such data visualizations can be presented in a number of forms or structures. For example, and without limitation, the data visualization may be presented to the consumer 24 in a chart structure, such as a bar graph, a line graph, a pie chart, or other known chart structure. Alternatively, data visualizations may be presented to the consumer 24 in any type of data structure that enables the method 700 to be performed as described herein.

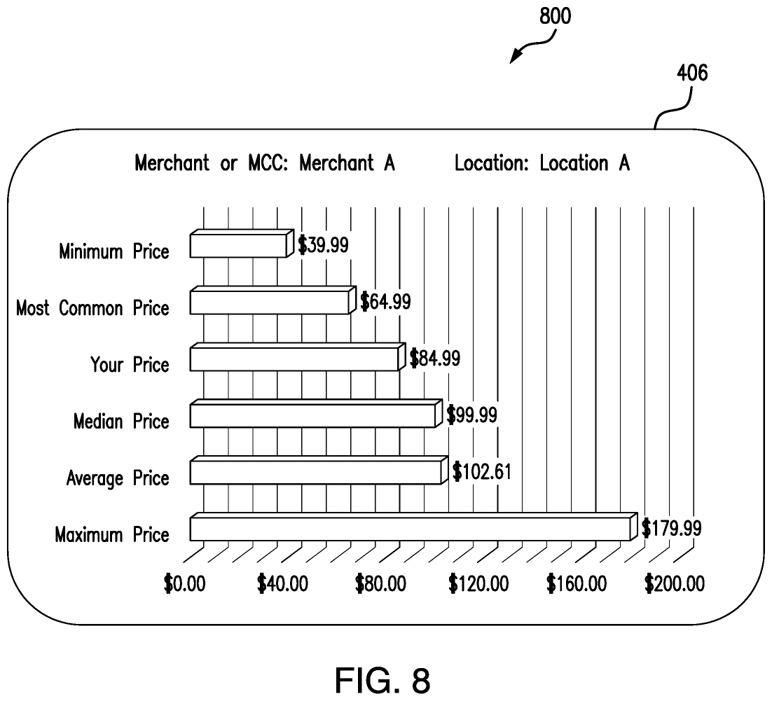

FIG. 8 is an example data visualization 800 of the one or more consumer transaction value properties determined in operation 712 and the one or more historical transaction value properties determined in operation 724 presented, for example, on a display device, such as the media output component 406 (shown in FIG. 4) of the user system 400. In the example embodiment, the X-axis of the data visualization 800 is an indication of the dollar amount of the transaction value properties. The Y-axis of the data visualization 800 includes the various transaction value properties being presented to the consumer 24. In the example embodiment, the “Merchant or MCC” value (e.g., Merchant A) represents the first input value received from the consumer 24. The “Location” value (e.g., Location A) represents the second input value received from the consumer 24.

Moving from top to bottom of the Y-axis, the “Minimum Price” represents the minimum transaction value identified in the historical transaction value properties of the second subset of transaction data. The “Most Common Price” represents the mode of the historical transaction value properties of the second subset of transaction data. “Your Price” represents the most recent transaction value of the consumer transaction data, although in some embodiments, it may represent the average transaction value of the consumer transaction data, taken over the predetermined period, as described above. The “Median Price” represents the median value (or middle value) of the historical transaction value properties of the second subset of transaction data. The “Average Price” represents the average value of the historical transaction value properties of the second subset of transaction data. And, the “Maximum Price” represents the maximum transaction value identified in the historical transaction value properties of the second subset of transaction data.

With reference back to FIG. 7, in one suitable embodiment, the method 700 includes, at an operation 728, determining for the one or more consumer transaction value properties a fair price score. The fair price score is based on the one or more historical transaction value properties. For example, and without limitation, in one suitable embodiment, the fair price score may be a “mean normalization” of the consumer transaction value property relative to the historical transaction value properties. The score resulting from a “mean normalization” represents a percentage value of the “range” that the consumer transaction value property differs from the “average value” of the historical transaction values. The following equation may be used to determine the fair price score.

$$A = \frac{B - {C}_{avg}}{{C}_{max} - {C}_{mi n}}$$

Where B equals the consumer transaction value property (e.g., the most recent consumer transaction value or average consumer transaction value), C_{avg} equals the mean of the historical transaction values, Cₘₐₓ equals the maximum historical transaction value, Cₘᵢₙ equals the minimum historical transaction value, and A is the fair price score. In the above equation, a negative fair price score (i.e., A<0) indicates that the consumer transaction value property is less than the average historical transaction value, whereas a positive fair price score (i.e., A<0) indicates that the consumer transaction value property is greater than the average historical transaction value.

As is understood from the above described methods, the consumer 24 who wishes to purchase a service, which is billed as a recurring payment, can request a fair price score from the fair price estimator module 28. If the consumer's fair price score is negative, the consumer 24 instantly knows that his or her price for the service is below average. However, if the consumer's fair price score is positive, the fair price estimator module 28 provides the consumer with the transaction data to enable the consumer to determine whether to continue with the service or to negotiate a better price. The fair price estimator module 28 facilitates the consumer 24 having access to actual payment transaction data to use in maximizing their value when seeking such services.

### ADDITIONAL CONSIDERATIONS

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A fair price estimator system comprising:
a memory device for storing data; and
a processor communicatively coupled to said memory device, said processor programmed to:
receive historical transaction data comprising a plurality of historical payment transactions between a plurality of account holders and a plurality of merchants, the historical transaction data including a merchant name, a merchant category code, and a merchant location associated with each of the historical payment transactions;
generate a first subset of transaction data from the historical transaction data based on one or more predetermined transaction parameters;
store the first subset of transaction data in said memory device;
receive, from a consumer, a first input value, the first input value including one or more of the following: a merchant name and a merchant category code that are included in the first subset of transaction data;
receive a second input value including a location identifier;
generate a second subset of transaction data from the first subset of transaction data based on the first and second input values received from the consumer;
determine one or more transaction value properties of the second subset of transaction data, each historical payment transaction including a transaction value; and
present to the consumer the one or more transaction value properties.

2. The fair price estimator system in accordance with claim 1,
the one or more predetermined transaction parameters comprising the following: a recurring transaction, an approved transaction, and a transaction value greater than zero (0).

3. The fair price estimator system in accordance with claim 1,
the operation of receiving, from the consumer, the first input value comprising:
receiving, from the consumer, one or more of the following: a merchant name selected from a list of one or more merchant names that are included in the first subset of transaction data and a merchant category code selected from a list of one or more merchant category codes that are included in the first subset of transaction data.

4. The fair price estimator system in accordance with claim 1,
the location identifier corresponding to at least one merchant location included in the first subset of transaction data.

5. The fair price estimator system in accordance with claim 4,
the operation of receiving the second input value comprising:
receiving, from the consumer, a location identifier selected from a list of one or more merchant locations that are contained in the first subset of transaction data.

6. The fair price estimator system in accordance with claim 4,
the location identifier comprising one or more of the following: a zip code, a city, and a state.

7. The fair price estimator system in accordance with claim 1,
the location identifier comprising one or more of the following: GPS coordinates, a zip code, a city, a state, and a distance threshold.

8. The fair price estimator system in accordance with claim 1,
the operation of generating the second subset of transaction data comprising:
identifying a first group of one or more of the historical payment transactions from the first subset of transaction data that include the first input value received from the consumer;
identifying a second group, selected from the first group, of one or more of the historical transactions that include the second input value; and
generating the second subset of transaction data from the second group of one or more of the historical payment transactions.

9. The fair price estimator system in accordance with claim 1,
the one or more transaction value properties comprising one or more of the following: a minimum transaction value, a maximum transaction value, a range of transaction values, a mean of the transaction values, a mode of the transaction values, and a median of the transaction values.

10. The fair price estimator system in accordance with claim 1,
the operation of presenting to the consumer the one or more transaction value properties comprising:
displaying the one or more transaction value properties in a data visualization based on a predetermined data visualization structure.

11. A fair price estimator system comprising:
a memory device for storing data; and
a processor communicatively coupled to said memory device, said processor programmed to:
receive, from a consumer, a consumer payment account number;
based on one or more predetermined transaction parameters, retrieve consumer transaction data corresponding to the consumer payment account number, the consumer transaction data corresponding to historical consumer payment transactions associated with the consumer payment account number, the consumer transaction data including a merchant name, a merchant category code, a transaction value, and a merchant location associated with each of the historical consumer payment transactions;
receive, from the consumer, a first input value, the first input value including one or more of the following: a merchant name and a merchant category code that are included in the consumer transaction data;
determine one or more consumer transaction value properties of the consumer transaction data based on the first input value received from the consumer;
retrieve historical transaction data comprising a plurality of historical payment transactions between a plurality of account holders and a plurality of merchants, the historical transaction data including a merchant name, a merchant category code, a transaction value, and a merchant location associated with each of the historical payment transactions;
generate a first subset of transaction data from the historical transaction data based on the one or more predetermined transaction parameters;
store the first subset of transaction data in said memory device;
receive, from the consumer, a second input value including a location identifier;
generate a second subset of transaction data from the first subset of transaction data based on the first and second input values received from the consumer;
determine one or more historical transaction value properties of the second subset of transaction data; and
present to the consumer the one or more consumer transaction value properties and the one or more historical transaction value properties.

12. The fair price estimator system in accordance with claim 11,
the one or more predetermined transaction parameters comprising the following: a recurring transaction, an approved transaction, and a transaction value greater than zero (0).

13. The fair price estimator system in accordance with claim 11,
said processor further programmed to:
determine from the consumer transaction data one or more merchant names and one or more merchant category codes associated with the historical consumer payment transactions; and
present to the consumer for selection, a list of the one or more merchant names and a list of the one or more merchant category codes associated with the historical consumer payment transactions,
the operation of receiving, from the consumer, the first input value comprising:
receiving, from the consumer, a selection of one or more of the following: a merchant name selected from the list of one or more merchant names and one of a merchant category code selected from the list of one or more merchant category codes.

14. The fair price estimator system in accordance with claim 11,
the location identifier corresponding to at least one merchant location included in the first subset of transaction data.

15. The fair price estimator system in accordance with claim 11,
the location identifier comprising one or more of the following: GPS coordinates, a zip code, a city, a state, and a distance threshold.

16. The fair price estimator system in accordance with claim 11,
the operation of generating the second subset of transaction data comprising:
identifying a first group of one or more of the historical payment transactions from the first subset of transaction data that include the first input value received from the consumer;
identifying a second group, selected from the first group, of one or more of the historical transactions that include the second input value received from the consumer; and
generating the second subset of transaction data from the second group of one or more of the historical transactions.

17. The fair price estimator system in accordance with claim 11,
the one or more historical transaction value properties comprising one or more of the following: a minimum transaction value, a maximum transaction value, a range of transaction values; a mean of the transaction values; a mode of the transaction values, and a median of the transaction values.

18. The fair price estimator system in accordance with claim 11,
the one or more consumer transaction value properties comprising one or more of the following: an average of the transaction values and a most recent transaction value.

19. The fair price estimator system in accordance with claim 11,
the operation of presenting to the consumer the one or more consumer transaction value properties and the one or more historical transaction value properties comprising:
displaying the one or more consumer transaction value properties and the one or more historical transaction value properties in a data visualization based on a predetermined data visualization structure.

20. The fair price estimator system in accordance with claim 11,
said processor further programmed to determine for the one or more consumer transaction value properties a fair price score, the fair price score being based on the one or more historical transaction value properties.
